(19) United States
(12) Patent Application Publication
(10) Pub. No.: US 2010/0127140 A1
(43) Pub. Date: May 27, 2010

(54) Suspension for a pressure sensitive touch display or panel

(76) Inventor: Gary Smith, Youngsville, NC (US)

Correspondence Address: OBER / KALER;C/O ROYAL W. CRAIG, 120 EAST BALTIMORE STREET, SUITE 800, BALTIMORE, MD, 21202, US

(21) Appl. No.: 12/590,450

(22) Filed: Nov. 6, 2009

Related U.S. Application Data
(63) Continuation-in-part of application No. 12/009,964, filed on Jan. 23, 2008.
(60) Provisional application No. 61/198,536, filed on Nov. 6, 2008.

(51) Int. Cl. F16M 13/02

(52) U.S. Cl. 248/220.1

(57) ABSTRACT

A mechanical suspension platform for sensor-based touch screen products that uses a suspension bracket with one or more suspension line channels that allow for a suspension line or cable to be inserted and wrapped around. The suspension brackets allow the suspension line to be strung so that one end pulls the touch plate towards the bottom plate and the other pulls along a diagonal. With one suspension bracket in each corner of the touch plate, the plate can be strung with the suspension line to create an optimal suspension for a force-based touch screen system.

### CROSS-REFERENCE TO RELATED APPLICATION(S)

The present application derives priority from U.S. provisional application Ser. No. 61/198,536 filed Nov. 6, 2008, and is a continuation-in-part of U.S. patent application Ser. No. 12/009,964 for “Integrated Force Sensitive Lens and Software”, filed 23 Jan. 2008 by Mölne et. al.

### BACKGROUND OF THE INVENTION

1. Field of the Invention

The present invention relates generally to input devices for electronics and, more particularly, to a suspension for a touch sensitive input panel or display especially suited for use in cellular phones and personal digital assistants (PDAs), PC Tablets, as well as laptops, PCs, office equipment, medical equipment, TVs Monitors, or any other device that uses touch sensitive displays or panels.

2. Description of the Background

Touch sensitive screens can detect the application of fingers and other passive objects. Touch screens are gaining in popularity and have been deployed in many products in recent years. A number of different technologies have been used to create touch sensitive touch screens and panels, such as resistive, capacitive, infrared, Surface Acoustic Wave (SAW) and others. Resistive pads, for example, comprise two conductive plates pressed together. The disadvantage of a resistive pad is that the resistive membrane material will wear out, initially resulting in further reduced clarity followed by dead spots. In addition, the production yield is typically rather poor and the technology has a few disadvantages such as a fixed (non-user adjustable) actuation force and the light throughput through the resistive membranes is typically only around 70% to 75%.

Capacitive touch screens/pads operate by measuring the capacitance of the passive object to ground, or by measuring the alteration of the transcapacitance between different sensors. An example of a capacitive touchpad is described in U.S. Pat. No. 5,495,077 to Miller. Capacitive pads are relatively expensive to manufacture compared to resistive, and can only detect objects with sufficient capacitance. Small objects, such as the end of a regular stylus or pen, do not have enough capacitance to ground or transcapacitance to be detected by a capacitive touchpad. The actuation force can also not be set and it may be as low as 0 gram force, that is, the touch screen registers a touch even before the user's finger touches the screen. This often leads to difficulties in implementing certain end-user features, such as handwriting recognition.

Surface acoustic wave (SAW) devices operate by emitting sound along the surface of the pad and measuring the interaction of the passive object with the sound. These devices work well, but are generally much too expensive for general applications. Infra red light based displays work in a similar fashion, but this technology typically adds a large size and price.

Finally, there are devices that use force sensors to measure the location and magnitude of the force exerted by the passive object on the touchpad. Force sensing technology is very interesting from both feature and cost perspective. A force sensitive touchpad will sense force applied by any sort of passive object, regardless of the electrical conductivity or composition of the object. Such devices were originally described in U.S. Pat. No. 3,657,475 to Peronneau et al. and U.S. Pat. No. 4,121,049 to Roeber. These devices measure the forces transmitted by the touchpad to a fixed frame at multiple points e.g., at the corners of the pad. Roeber discloses a mathematical formula for deriving the position and magnitude of the force applied by a passive object from the forces measured at the multiple points.

For example, U.S. Pat. No. 4,511,760 to Garwin et al. issued Apr. 16, 1985 shows a force sensing data input device responding to the release of pressure force. The input surface is provided with a transparent faceplate mounted on force-sensing piezoelectric transducers. Preferably, four piezoelectric transducers are provided, one at each corner of a rectangular opening formed in the frame. To determine the point of application of force on the input surface, the outputs of the four transducers are first summed. To constitute a valid data entry attempt, the sum must exceed a first threshold while the user is pushing on the input surface. When the user releases his finger, a peak of the sum is detected, which is of opposite polarity from the polarity of the sum for the pushing direction. The individual outputs of the four sensors at the time that the peak of the sum occurs are used to calculate the point of application of the force.

United States Patent Application 20030085882 by Lu published May 8, 2003 shows a touch pad device having a support layer with a plurality of strain gauges in a matrix configuration. A touch layer is disposed on top of the strain gauge matrix, the touch layer being joined to the top of the strain gauge matrix. Sensor wires connect the strain gauges to a processor which is programmed with an algorithm to measure the location and pressure of simultaneous, multiple touches.

United States Patent Applications 20040108995 and 20040021643 both by Hoshino et al. show a display unit with touch panel mounted above a display via four differentially-mounted sensors. The pressure sensors detect force with which a pointing device such as a finger pushes the panel surface, in real time. The force P with which the pointing device such as a finger pushes the panel surface is found from the following equation irrespective of the pointing position: P=a+b+c+d−a0+b0+c0+d0, which equation detects dragging of a cursor.

United States Patent Application 20050156901 by Ma et al. issued Jul. 21, 2005 shows a touch screen display system with a display screen and overlying touch surface. An imaging system determines an angular position on the touch surface of the object coming in contact with the touch surface.

United States Patent Application 20060119589 by Rosenberg shows a haptic feedback feature for touchpads and other touch controls in which at least one actuator is coupled to the touch input device and outputs a force to provide a haptic sensation to the user contacting the touch surface. Output haptic sensations on the touch input device can include pulses, vibrations, and spatial textures. The claims require touch panel mounted on a suspension, and an actuator configured to output haptic feedback to the compliant suspension which amplifies the haptic feedback.

United States Patent Application 20060016272 by Chang published Jan. 26, 2006 shows a thin film touch pad with opposed sensor elements that generate an electrical signal that is proportional to both the applied pressure and the surface area at the location of the applied pressure. As a result of the complementary orientation and overlapping for these sensor elements, the first and second sensor elements generate an asymmetric pair of signals that uniquely define the applied pressure by position and magnitude.

U.S. Pat. No. 6,879,318 by Chan et al. issued Apr. 12, 2005 shows a touch screen mounting assembly for a liquid crystal display panel LCD including a bottom frame, a backlight panel seated in the frame and that has a plurality of pressure-sensitive transducers mounted thereon, a liquid crystal display panel, and a top frame for exerting pressure when mounted to the bottom frame such that a plurality of compressible springs biases the LCD panel towards the bottom frame when touched or contacted by a user. The claims require the bottom and top frame assembly with backlight panel mounted therein on springs, and an overlying LCD panel.

The market success for force based touch screens and pads has so far been very limited for various reasons. Current implementations employ complex mechanical structures and appropriate force-sensing sensors. A method to overcome the mechanical complexities (promising a low cost and small size penalty) is described in PCT Publication number WO 2008115408A1 by Brown et al., which employs a mechanical stringing concept to ensure that the touch screen will not move in the xy-plane. Such translational movement creates uncontrolled friction or forces, and tends to distort the sensor readings. Nevertheless, the device is free to move frictionless in the z-plane thereby ensuring that all of the touch force will be distributed to four force sensors. The readings from the sensors are then used to calculate the exact touch coordinate(s). Although the Brown et al. suspension system can be manufactured at a low cost both in terms of material as well as assembly costs, there are significant constraints involved in the product implementation. For example, building a product where the touch surface is a glass plane floating over an underlying display typically requires drilling of four holes through the glass in order to string the suspension mechanism. Alternatively, the suspension lines can be wrapped around the glass plates. Both approaches provide suitable functionally but require costly drilling of holes in glass or smoothing/rounding of glass edges. This adds significant manufacturing cost to the overall structure. In addition, the resulting suspension line on the top side of the glass plate complicates mechanical add-on items, such as water seals. Another mechanical problem is the placement of sensors and support for multiple sensor types. An ideal mechanical platform would allow production of one uniform mechanical structure, regardless of which force sensors are used (larger more precise, or smaller and lower cost sensors).

It would be greatly advantageous to provide a mechanical suspension platform for a touch panel or display that can easily accommodate different sensor sizes. The same platform components should be capable of accommodating different sensor sizes/shapes, should allow for a more cost efficient suspension mechanism, and should be reusable from one product implementation to the next.

### SUMMARY OF THE INVENTION

It is, therefore, an object of the present innovation to allow for cost efficient design and manufacturing of force sensing sensor-based touch screen products of different sizes, designs and applications with one and the same conceptual component.

It is another object to provide a suspension solution that can be implemented and assembled at a low cost, and yet support different sensor types and sizes without any conceptual changes and a minimum of component changes.

These and other objects are accomplished by a mechanical suspension platform for sensor-based touch screen products that uses a suspension elbow component. The elbow component, for example, is formed with a 90 degree angled-V with diverging legs. The two legs of the V are shaped with mechanical loops that allow for the suspension line or cable to be inserted and wrapped around. The suspension line can now be placed so that one end pulls the touch plate towards the bottom plate and the other end pulls the elbow component along the side of the top (or bottom plate) at a diagonal. With one elbow component in each corner of the touch plate, the plate can be strung with the suspension line to create an optimal suspension method for the force based touch screen system. If needed, the same elbow component or similar component can also be used for the bottom plate. The elbow component allows a simple and fast connection to the touch (or back) plane by glue or similar strong adhesive.

By shaping the component into a 90 degree angle-V, the elbow component can be placed at each corner without adding much space for the actual suspension string, which typically runs right outside the four sides of the display module in a force based touch screen. In addition, the elbow component can extend and wrap around the edge of the touch plane component in order to provide a larger area for adhesive and to provide self adjusting component placement.

In addition, the elbow component can be split into 2 basic parts, where the main part is an elbow bracket, less an empty space, such as a round hole. In this hole, circular sensor activators can then be placed, there the height of this cylinder will depend on the distance between the touch and back plate and the sensor height. The material and surface shape can also be varied depending on any specific requirements that may exist for the force sensor used in the mechanical structure.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 represents part of a touch screen system, showing a force sensor between the touch lens and the back cover or LCD module.

FIG. 2 illustrates a figure-8 suspension mechanism on one of the 4 sides of the touch screen system, holding the touch lens and the back ground aligned.

FIG. 3 illustrates how a touch plate (or a bottom plate) in a touch system assembly can be strung through four pre-drilled holes in each corner.

FIG. 4 illustrates a stringing pattern which can be used to create a force pattern that pulls the touch screen in towards center and eliminates movement in xy-plane.

FIG. 5 illustrates the bottom view of a display assembly with a suspension bracket according to the present invention in each corner underneath the display bezel.

FIG. 6 illustrates part of a touch screen module with a suspension bracket as in FIG. 5 and suspension stringing.

FIG. 7 illustrates the suspension bracket of the present invention integrated onto the underside of the bezel in a touch screen display module.

FIG. 8 illustrate a suspension bracket with activator and line channels for suspension stringing.

FIG. 9 illustrates an alternative embodiment of suspension bracket.

FIG. 10 illustrates an alternative view of FIG. 9.

FIG. 11 illustrates the forces within the above-described suspension system.

FIG. 12 illustrates the forces within the suspension system using the alternative bracket of FIG. 9.

FIG. 13 illustrates a suspension bracket including a force sensor.

FIG. 14 illustrates an alternative embodiment of suspension bracket including a force sensor.

### DETAILED DESCRIPTION OF THE PREFERRED EMBODIMENT

The present invention is a suspension platform for a touch sensitive input panel or display especially suited for use in cellular phones and personal digital assistants (PDAs), PC Tablets, as well as laptops, PCs, office equipment, medical equipment, TV Monitors, or any other device that uses touch sensitive displays or panels.

The suspension platform presumes the use of a force sensor-based touch screen implementation, such as the technology disclosed in existing patent filings and publications such as U.S. application 2008003374 for “integrated Feature for Frictionless Movement of Force Sensitive Touch Screen, filed Mar. 14, 2008 by Brown et. al., and U.S. patent application Ser. No. 12/009,964 for “Integrated Force Sensitive Lens and Software”, filed 23 Jan. 2008 by Mölne et. al.

As is described in these patents, it is known to use a plurality (e.g., four) force sensors to locate a touch point on a touch screen or touch pad. However, prior mechanical implementations introduce such high levels of disturbing forces that the position calculation based on the differential force sensor readings have been extremely poor. What is desirable is a mechanical suspension system where the lens or display movement is close to completely eliminated in the xy-plane, while the system still allows a close to friction-less movement in the z-plane. The above-cited PCT Publication number WO 2008115408A1 uses a line or a thin wire wrapped around the rigid touch lens or display module to form four figure-8 loops, with force sensors placed between the two rigid planes.

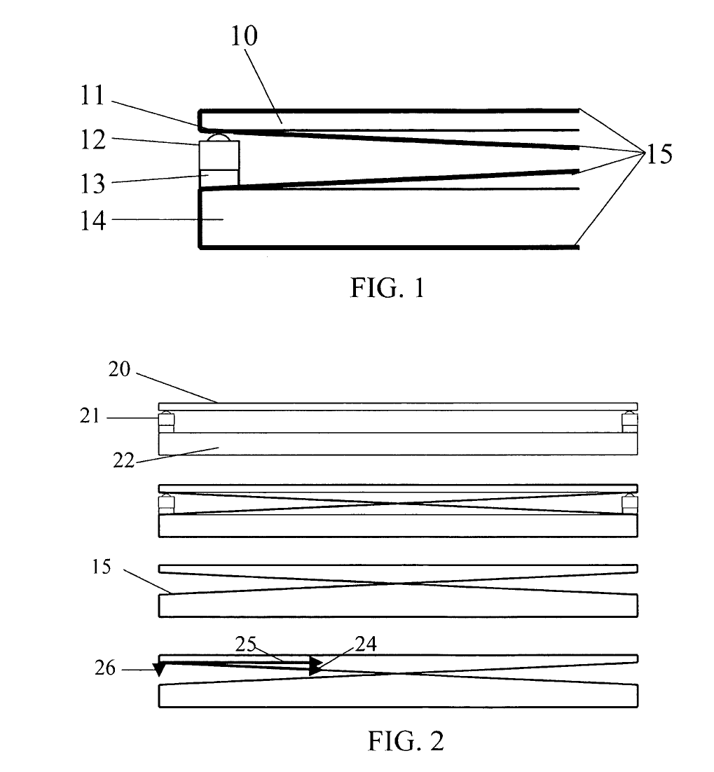

FIG. 1 illustrates how a touch panel, such as a glass plane 10 is kept in place by the suspension line 15, which presses the top plane 10 towards the bottom/base plane 14, with force sensors 12 between each plane.

FIG. 2 shows the similar configuration as in FIG. 1 from a full side view, wherein a glass plane 20 serves as the touch surface and a display module 22 serves as the base plane. In each of the four corners there is a force sensor 21. One or more suspension line(s) 15 hold the plates together. The lines 15 may be attached as four separate figure 8-loops, or as one continuous wire forming all four figure 8-loops. The suspension wire/line 15 is fastened with a predetermined level of built-in tension. The tension force 24 in the line 15 will primarily pull each corner towards each other in the xy-plane 25, but a smaller fraction of the tension force 24 will also result in a pre-loading force 26 in the z-plane. This force 26 holds the planes together and ensures that the force sensors 21 are always in contact. The force 26 also acts as a vibration damper since it pulls the top plane 20 towards the bottom plane 22 even if the system is moving or vibrating.

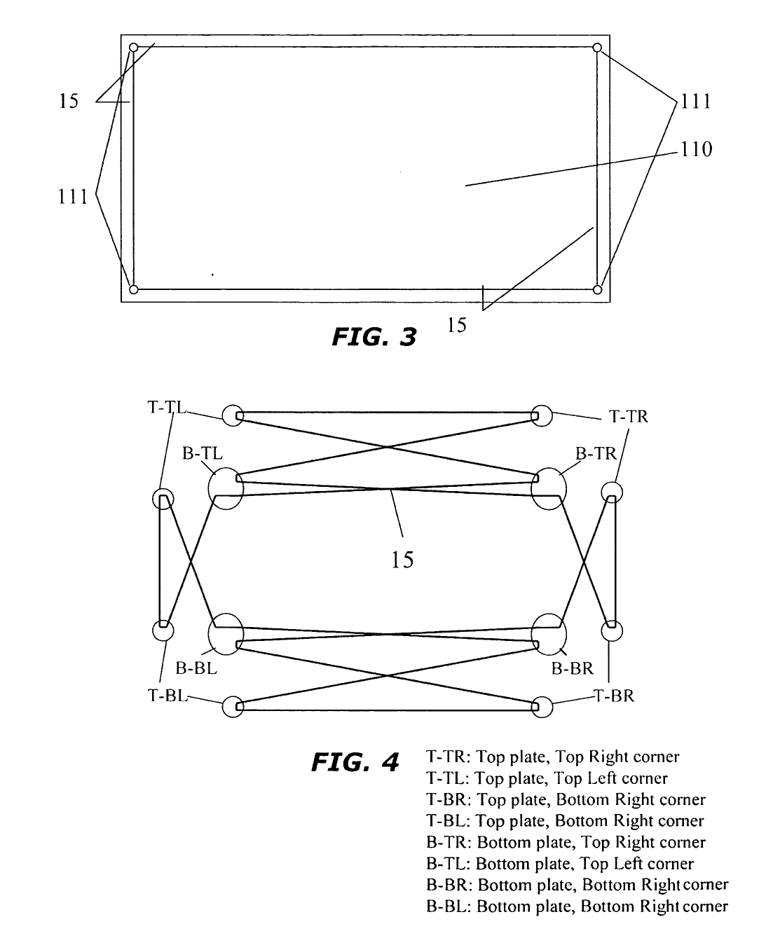

FIG. 3 illustrates one very efficient implementation, where the touch surface, such as a rigid glass or plastic plane 110 is modified with four holes 111, one in each corner. With these holes 111 in place it is very simple to attach the suspension wire/line 15 to the system. The underlying display or base plane (such as bottom plane 22 in FIG. 2) may also be modified with similar holes in the same location to ensure a simple assembly of the suspension solution.

FIG. 4 illustrates an exemplary stringing sequence showing how two planes can be strung with one wire/line 15. The sequence goes T-TR: Top plate, Top Right corner, to B-TL: Bottom plate, Top Left corner; to B-TR: Bottom plate, Top Right corner, to B-TL: Bottom plate, Top Left corner; to T-BL: Top plate, Bottom Right corner; to T-TL: Top plate, Top Left corner; to B-BL: Bottom plate, Bottom Right corner; to B-BR: Bottom plate, Bottom Right corner; to T-BL: Top plate, Bottom Right corner; to T-BR: Top plate, Bottom Right corner; to to B-BL: Bottom plate, Bottom Right corner; to B-BR: Bottom plate, Bottom Right corner; to T-TR: Top plate, Top Right corner; to T-BR: Top plate, Bottom Right corner; to B-TR: Bottom plate, Top Right corner; to B-TL: Bottom plate, Top Left corner; back to T-TR: Top plate, Top Right corner.

While this suspension mechanism works very well and allows force sensor based touch screens to operate with acceptable accuracy levels, applying the line/wire assembly 15 as described in the above mentioned patents has a few limitations:
Making or drilling holes in the planes, especially the glass plane can be both complex and expensive.
The suspension solutions, wrapping the wire/line 15 around the sides of the planes or through holes in the planes will result in the line 15 being exposed on top of the display bezel and underneath the bottom plate of the display. The line 15 can then more easily be damaged and it can also make the implementation of the display module more complicated, for example when applying a water or a dust seal against the display module.

The present invention is a basic bracket that can be mounted inside the display housing. This bracket supports the wiring/stringing, is easily mounted in the correct place (minimizing tolerance issues), is reusable from one touch screen module to another independent of display size, and it also supports multiple force sensor types and sizes.

FIG. 8 illustrates one implementation of this bracket 54. The bracket 54 is, for example, formed as a 90 degree angled-V member with diverging legs so as to conform to the corners of the housing. The suspension bracket 54 is designed to be mounted inside/underneath a display bezel or display back chassis. The two legs of the bracket 54 are each equipped with a line channel 53. These two channels 53 act as holders for the suspension line 15. The suspension bracket 54 is also equipped with an activator 55. The activator 55 may be a separate component, and may be made of the same or a different material then the suspension bracket 54. The purpose of the activator 55 is to support the active area of the corner-mounted force sensor. This way, if a different force sensor is used, only the activator needs to change. The suspension line or cable 15 can be inserted and wrapped around the two channels 53 in such as way that one end pulls the touch plate towards the bottom plate and the other end pulls the elbow component along the side of the top (or bottom plate) at a diagonal. With one suspension bracket 54 in each corner of the touch plate, the plate can be strung with the suspension line 15 to create an optimal suspension method for the force based touch screen system. If needed, the same suspension bracket 54 or similar component can also be used for the bottom plate. The suspension bracket 54 allows a simple and fast connection to the touch (or back) plane by glue or similar strong adhesive.

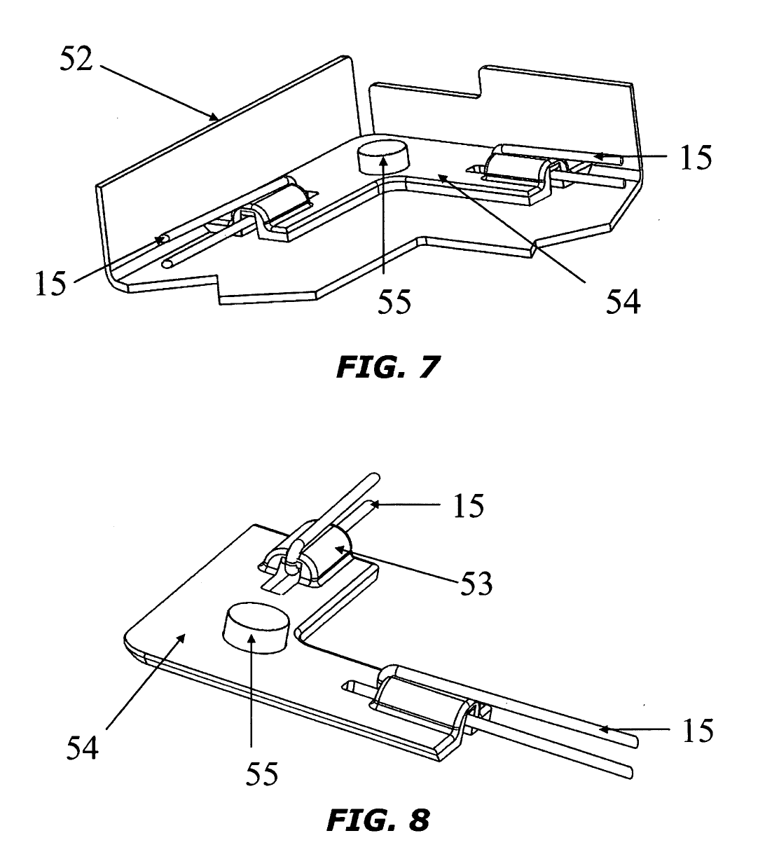

FIG. 7 shows the suspension bracket 54 mounted in the corner of a display bezel 52. As the suspension bracket 54 is mounted underneath the bezel 52, it will be hidden from view and interference.

FIG. 6 is a side perspective view illustrating a complete corner of a touch sensitive display module (except for the force sensor). In this illustration, the force sensor would be mounted on the bottom of chassis 51 of the display module. Once assembled, the force sensor will touch the surface of the activator 55. Here, the suspension bracket 54 may only be used for the display bezel (the front side of the display module) 52, in which case the suspension line 15 is strung through the line channels 53 of the suspension bracket 54 and through holes (as illustrated at top) made directly into the back chassis of the display module. As an alternative implementation, a second suspension bracket 54 can be added for the line 15 to the flat back chassis (eliminating holes). If a second suspension bracket is used, this would preferably omit any protruding activator 55, and may be a flat surface to simplify the mounting and to provide a flat and rigid surface for the force sensor to be mounted on.

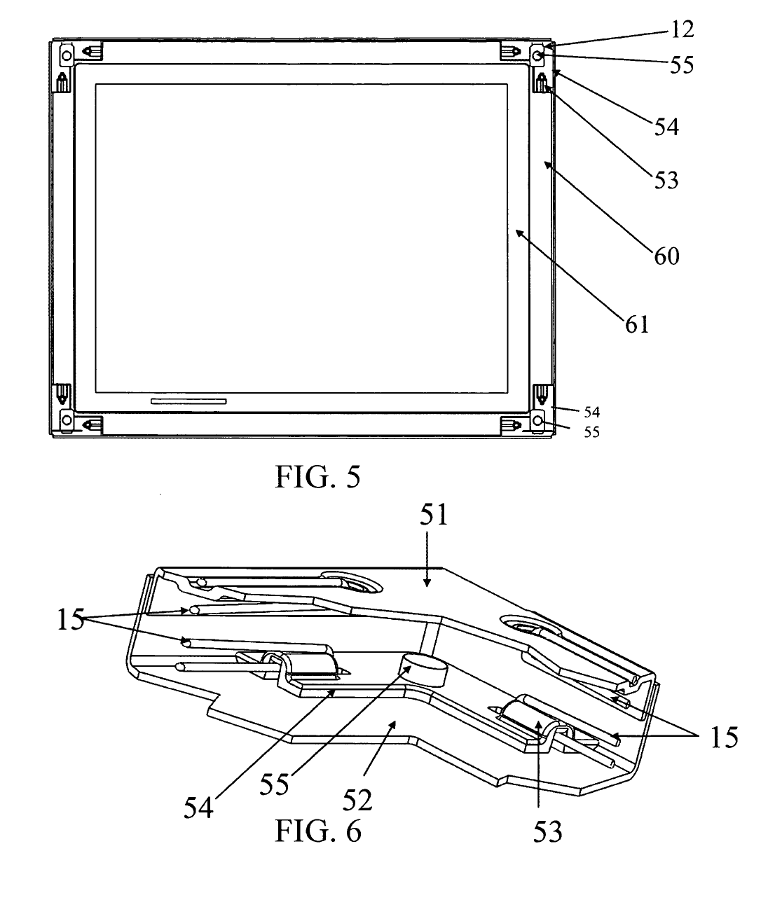

FIG. 5 is a rear view illustrating the backside of a display bezel 60 for a touch screen equipped display 61. Here a suspension bracket 54 is mounted in each corner of the bezel. In order to keep cost low, the suspension brackets 54 can be manufactured in a conventional plastic molding process, using a reinforced plastic, such as nylon. The suspension bracket 54 is then typically mounted onto the chassis 51 of the display module using a fast curing adhesive. In this illustration, the activator 55 can be viewed as a circle underneath the force sensor 12 footprint.

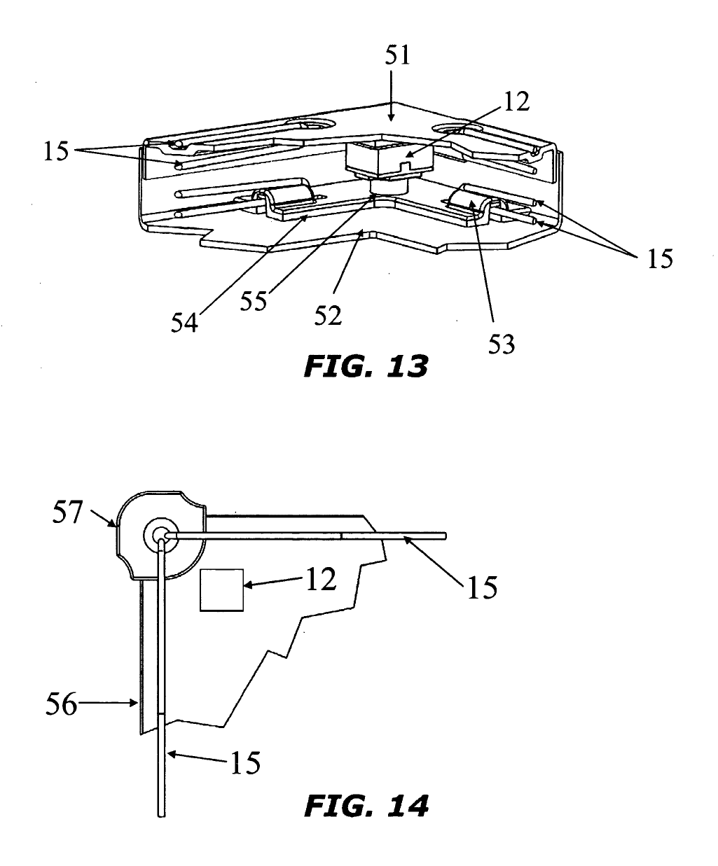

The placement of the force sensor 12 is also illustrated in FIG. 13, where the force sensor 12 is mounted on the back chassis 51 and touching the activator 55 of the suspension brackets 54. As discussed previously, the suspension mechanism via the line tension will not only position the two planes in a stable position in the xy-plane, but will also create a pre-loading force in the z-plane that will ensure that the force sensors 12 are always in contact with the activators 55. With no touches on the touch screen, the force sensitive touch screen system filters out the pre-loading force and only the differential force in the z-plane will be registered when a user touches the touch surface. The operational details of the differential force-sensing system is further described in co-pending U.S. patent application Ser. No. 12/009,964.

One skilled in the art should readily understand that the suspension brackets 54 described above may take on others shapes, such as being extended to wrap around the edge of the touch plane component in order to provide a larger area for surface contact for various strengths and adhesion to the plane component. In all such cases the suspension brackets 54 provide precision location of the suspension lines and force sensor placement.

The suspension bracket described above is very much a component optimized for integration into a small enclosed module, such as a display module with built in touch screen sensors and mechanics. Some implementation of the same force based touch screen technology requires a touch plane, most often a rigid and durable computer glass plane, which is separated from an underlying display.

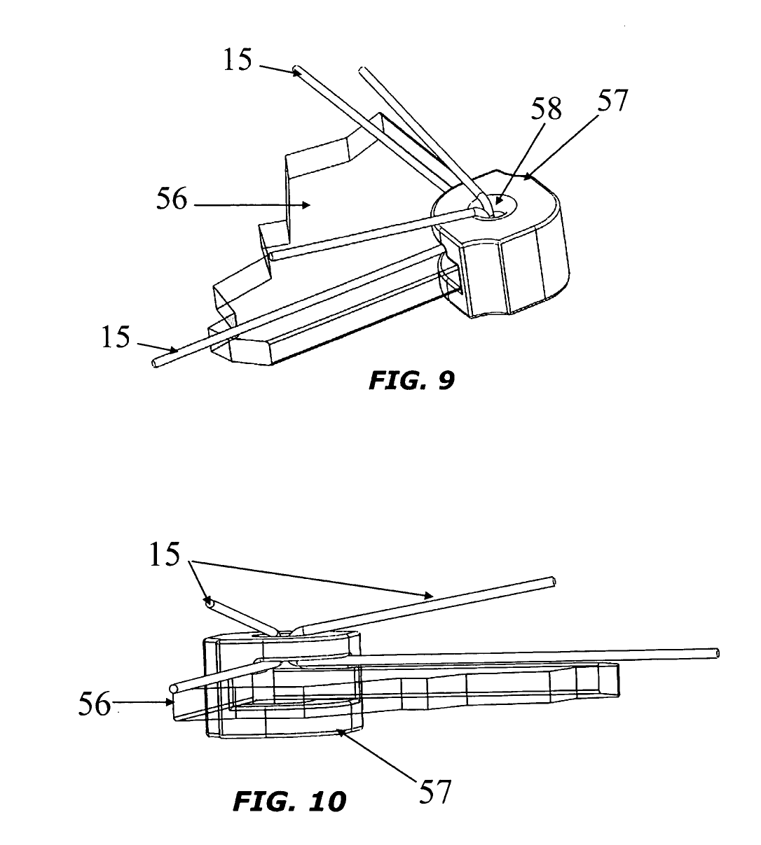

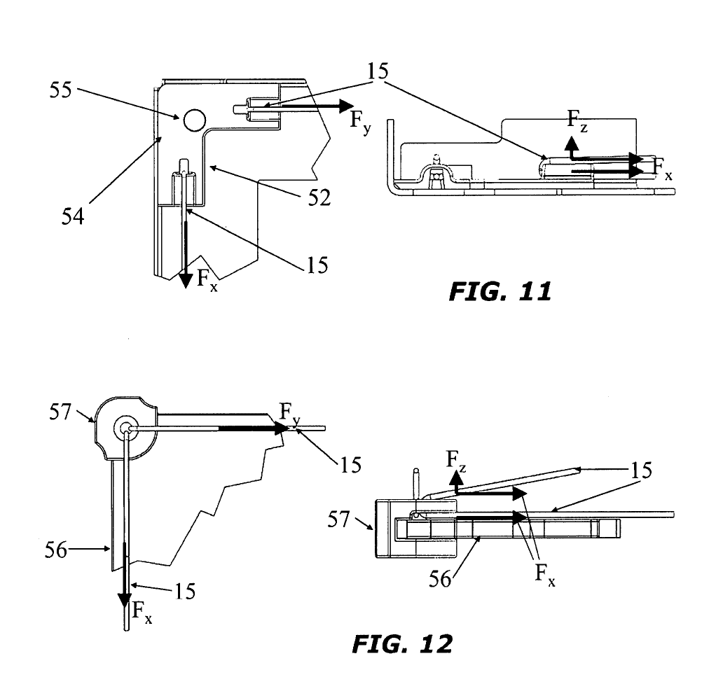

For example, an alternative implementation is illustrated in FIGS. 9 and 10. In this embodiment a surface mounted suspension bracket 57 is formed as an annular receptacle that engages the touch surface 56. In this specific touch screen implementation the suspension bracket 57 was designed to have a small footprint due to other mechanical constraints, however, the shape of this bracket 57 may be varied, such as described in the previous section. In this embodiment, the two line channels are replaced by one common line channel 58 formed as a through-hole through suspension bracket 57. Functionally, the suspension bracket 57 emulates the drilled holes described in PTC/US2008/003374, but since it can be retrofit it comes at a much lower cost. The bracket can be mass-produced of, for example, nylon, for a very low cost, creating a substantial saving compared to drilling or making holes in the glass plane through water jet.

In this illustration, the suspension bracket is shown without an activator. FIG. 14 illustrates an implementation wherein the glass plane 56 rests directly on the force sensor 12, but an activator (such as activator 55 described above) can obviously be used in this implementation as well.

As illustrated in FIG. 12, the same forces are present in this implementation, where most of the line 15 tension Fx, Fy is forcing the two planes to be locked in the xy-plane while a smaller z-plane force vector Fz presses the touch panel 56 towards the force sensor. Even though this suspension bracket 57 wraps around the corner of the touch plane, it still has the same characteristics of the suspension bracket 54 that is described in FIG. 9. Both brackets supports the same suspension stringing and both implementations are self aligned when mounted onto or into the mechanical assembly.

It should now be apparent that the above-described suspension bracket 54, 57 and their functional equivalents can be conveniently mounted inside the display housing and will support the wiring/stringing, they are self-aligning and more easily mounted in the correct place (minimizing tolerance issues), are reusable from one touch screen module to another independent on display size, and also supports multiple force sensor types.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A suspension bracket for mounting a differential pressure touch screen display in
a housing, comprising:
a bracket secured in said housing, said bracket being formed with at least one line channel for passing a suspension line; and
a suspension line passed through the line channel of said bracket and secured to said touch screen display.
